(19) United States
(12) Patent Application Publication
(10) Pub. No.: US 2015/0189039 A1
(43) Pub. Date: Jul. 2, 2015

(54) Memory Data Access Method and Apparatus, and System

(71) Applicant: Huawei Technologies Co., Ltd., Shenzhen (CN)

(72) Inventors: Yongbo Cheng, Chengdu (CN); Chenghong He, Shenzhen (CN); Kejia Lan, Chengdu (CN)

(21) Appl. No.: 14/581,577

(22) Filed: Dec. 23, 2014

(30) Foreign Application Priority Data
Dec. 26, 2013 (CN) 201310733844.2

(51) Int. Cl. H04L 29/08; G06F 12/08

(52) U.S. Cl. CPC H04L 67/2852; H04L 67/2842; G06F 12/0831; G06F 2212/622

(57) ABSTRACT

A memory data access method and apparatus, and a system are provided. In the embodiments of the present invention, when it is determined, according to a preset rule, that memory data located on a remote node needs to be frequently accessed, the memory data located on the remote node is replicated to a memory of a local node, and then the memory data located on the remote node is accessed from the memory of the local node. Because a delay of accessing a memory of a processor in a local node is much less than a delay of accessing a memory of a remote processor, when memory data located on a remote node needs to be frequently accessed, a delay of reading the memory data located on the remote node may be significantly reduced by using the solution, thereby improving system performance.

### CROSS-REFERENCE TO RELATED APPLICATION

This application claims priority to Chinese Patent Application No. 201310733844.2, filed on Dec. 26, 2013, which is hereby incorporated by reference in its entirety.

### TECHNICAL FIELD

The present invention relates to the field of communications technologies, and in particular, to a memory data access method and apparatus, and a system.

### BACKGROUND

In a cache coherence non-uniform memory access (CC-NUMA) system established by high-performance processors, because a processor itself has a limited expansion capability, it is required to distribute processors in multiple nodes. For example, a node may be formed by more than two processors, and then multi-processor expansion is performed between nodes by using a node controller (NC), to increase the number of parallel processing processors, and improve system performance.

In the CC-NUMA system, each processor has its own layer 3 cache (L3), and may perform memory expansion. All processors in each node may coherently access their own memories, memories of other processors in the same node, and memories of processors in other nodes in the system. However, a delay of accessing a memory of a processor in another node in the system (that is, accessing a memory of a remote processor) is several times a delay of accessing a memory of a processor in a local node.

In a process of researching and practicing the prior art, the inventor of the present invention finds that, if one process needs to access excessive memory data located on a remote node, a processor spends most time on a delay of waiting for a response of the memory data located on the remote node, which leads to severe performance degradation of a system.

### SUMMARY

Embodiments of the present invention provide a memory data access method and apparatus, and a system, which may reduce a delay of reading memory data of a remote node, and improve system performance.

According to a first aspect, an embodiment of the present invention provides a memory data access method, where the method is applied to a cache coherence non-uniform memory access system, and includes, when it is determined, according to a preset rule, that memory data located on a remote node needs to be frequently accessed, replicating the memory data located on the remote node to a memory of a local node; and accessing the memory data located on the remote node from the memory of the local node.

In a first possible implementation manner, with reference to the first aspect, the replicating the memory data located on the remote node to a memory of a local node includes sending a data request to the remote node, where the data request carries a physical address of requested memory data; receiving the memory data returned by the remote node according to the physical address; and after exclusive permission for a target physical address in the memory of the local node is acquired, writing the received memory data to the target physical address.

In a second possible implementation manner, with reference to the first possible implementation manner of the first aspect, the when it is determined, according to a preset rule, that memory data located on a remote node needs to be frequently accessed includes monitoring a virtual-physical address mapping table, where the virtual-physical address mapping table is used to store a mapping relationship between a virtual address and a physical address of the memory data; and when it is determined that the number of physical addresses that are in the virtual-physical address mapping table and point to the remote node is greater than a preset threshold, determining that the memory data located on the remote node needs to be frequently accessed.

In a third possible implementation manner, with reference to the second possible implementation manner of the first aspect, after the writing the received memory data to the target physical address, the method further includes updating the physical address, in the virtual-physical address mapping table, of the received memory data to the target physical address.

In a fourth possible implementation manner, with reference to the first aspect, or the first or second possible implementation manner of the first aspect, the memory data located on the remote node may be replicated to the memory of the local node in a unit of memory data page, and before the replicating the memory data located on the remote node to a memory of a local node, the method further includes locking a memory data page on which the memory data that needs to be replicated is located; and after the replicating the memory data located on the remote node to a memory of a local node, the method further includes unlocking the memory data page on which the replicated memory data is located.

According to a second aspect, an embodiment of the present invention further provides a memory data access apparatus, where the apparatus is applied to a cache coherence non-uniform memory access system, and includes a replicating unit and an access unit, where the replicating unit is configured to, when it is determined, according to a preset rule, that memory data located on a remote node needs to be frequently accessed, replicate the memory data located on the remote node to a memory of a local node; and the access unit is configured to access the memory data located on the remote node from the memory of the local node.

In a first possible implementation manner, with reference to the second aspect, the replicating unit includes a request subunit, a receiving subunit, and a write subunit, where the request subunit is configured to, when it is determined, according to the preset rule, that the memory data located on the remote node needs to be frequently accessed, send a data request to the remote node, where the data request carries a physical address of requested memory data; the receiving subunit is configured to receive the memory data returned by the remote node according to the physical address; and the write subunit is configured to, after exclusive permission for a target physical address in the memory of the local node is acquired, write the received memory data to the target physical address.

In a second possible implementation manner, with reference to the first possible implementation manner of the second aspect, where the request subunit is configured to monitor a virtual-physical address mapping table, where the virtual-physical address mapping table is used to store a mapping relationship between a virtual address and a physical address of the memory data; and when it is determined that the number of physical addresses that are in the virtual-physical address mapping table and point to the remote node is greater than a preset threshold, send the data request to the remote node, where the data request carries the physical address of the requested memory data.

In a third possible implementation manner, with reference to the second possible implementation manner of the second aspect, the replicating unit further includes an updating subunit, where the updating subunit is configured to update the physical address, in the virtual-physical address mapping table, of the received memory data to the target physical address.

In a fourth possible implementation manner, with reference to the second aspect, or the first or second possible implementation manner of the second aspect, the memory data access apparatus further includes a locking unit and an unlocking unit, where the replicating unit is configured to replicate the memory data located on the remote node to the memory of the local node in a unit of memory data page; the locking unit is configured to, before the memory data located on the remote node is replicated to the memory of the local node, lock a memory data page on which the memory data that needs to be replicated is located; and the unlocking unit is configured to, after the memory data located on the remote node is replicated to the memory of the local node, unlock the memory data page on which the replicated memory data is located.

According to a third aspect, an embodiment of the present invention further provides a communications system, including any memory data access apparatus provided by the embodiments of the present invention.

In the embodiments of the present invention, when it is determined, according to a preset rule, that memory data located on a remote node needs to be frequently accessed, the memory data located on the remote node is replicated to a memory of a local node (that is, the memory data located on the remote node is moved to the local node), and then the memory data located on the remote node is accessed from the memory of the local node. Because a delay of accessing a memory of a processor in a local node is much less than a delay of accessing a memory of a remote processor, even if time for moving the memory data is added, when the memory data located on a remote node needs to be frequently accessed, a delay of reading the memory data located on the remote node may be significantly reduced by using the solution, thereby significantly improving system performance.

### BRIEF DESCRIPTION OF DRAWINGS

To describe the technical solutions in the embodiments of the present invention more clearly, the following briefly introduces the accompanying drawings required for describing the embodiments. The accompanying drawings in the following description show merely some embodiments of the present invention, and a person skilled in the art may still derive other drawings from these accompanying drawings without creative efforts.

FIG. 1 is a flowchart of a memory data access method according to an embodiment of the present invention;

FIG. 2A is a schematic structural diagram of a CC-NUMA system according to an embodiment of the present invention;

FIG. 2B is another flowchart of a memory data access method according to an embodiment of the present invention;

FIG. 2C is schematic diagram of a scenario of a memory data access method according to an embodiment of the present invention;

FIG. 3 is still another flowchart of a memory data access method according to an embodiment of the present invention;

FIG. 4 is a schematic structural diagram of a memory data access apparatus according to an embodiment of the present invention; and

FIG. 5 is a schematic structural diagram of a network device according to an embodiment of the present invention.

### DESCRIPTION OF EMBODIMENTS

The following clearly describes the technical solutions in the embodiments of the present invention with reference to the accompanying drawings in the embodiments of the present invention. The described embodiments are merely a part rather than all of the embodiments of the present invention. All other embodiments obtained by a person skilled in the art based on the embodiments of the present invention without creative efforts shall fall within the protection scope of the present invention.

The embodiments of the present invention provide a memory data access method and apparatus, and a system, which are separately described below in detail.

### Embodiment 1

The embodiment is described from a perspective of a memory data access apparatus. The memory data access apparatus may be a device such as an NC.

A memory data access method is applied to a CC-NUMA system, and includes, when it is determined, according to a preset rule, that memory data located on a remote node needs to be frequently accessed, replicating the memory data located on the remote node to a memory of a local node, and accessing the memory data located on the remote node from the memory of the local node.

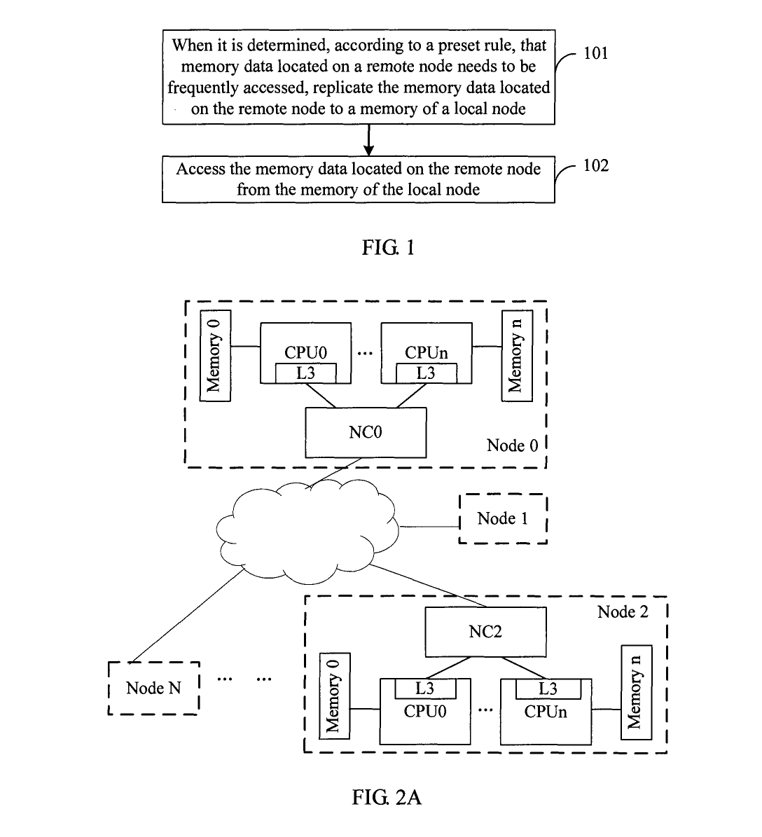

As shown in FIG. 1, a specific process may be as follows.

101: When it is determined, according to a preset rule, that memory data located on a remote node needs to be frequently accessed, replicate the memory data located on the remote node to a memory of a local node. For example, the step may be as follows.

When it is determined, according to the preset rule, that the memory data located on the remote node needs to be frequently accessed, sending a data request to the remote node, where the data request carries information such as a physical address of requested memory data; receiving the memory data returned by the remote node according to the physical address; and after exclusive permission for a target physical address in the memory of the local node is acquired, writing the received memory data to the target physical address.

The preset rule may be set according to a requirement of an actual application. That is, there may be multiple manners of determining whether the memory data located on the remote node is frequently accessed. For example, a virtual-physical address mapping table may be monitored, and if the number of physical addresses that are in the virtual-physical address mapping table and point to the remote node is greater than a preset threshold, it indicates that the memory data located on the remote node needs to be frequently accessed. The virtual-physical address mapping table is used to store a mapping relationship between a virtual address and a physical address of the memory data, and the threshold may be set according to a requirement of an actual application.

For example, that a process of a node0 (Node 0) requests latest memory data of a physical address P(A) from a node1 (Node 1) is used as an example, the step may be as follows.

The process of the node0 requests the latest memory data of the physical address P(A) from the node1.

The process of the node0 obtains memory data Data(A) that is responded by the node1 and corresponds to the physical address P(A).

The process of the node0 requests exclusive permission for a target physical address P(B) in the node0.

The process of the node0 obtains the exclusive permission for the target physical address P(B) in the node0.

The process of the node0 writes the memory data Data(A) to the target physical address P(B), and the memory data is written back till now.

In addition, after the received memory data is written to the target physical address, that is, after the memory data is written back, the physical address, in the virtual-physical address mapping table, of the received memory data may further be updated to the target physical address. For example, V(A)->P(A) is changed into V(A)->P(B). In this way, when the process of the node0 accesses the address V(A) subsequently, the address V(A) may be mapped to the address P(B) in a local node, so that the process may work with a low delay.

Generally, both memory loading and an address mapping table are performed in a unit of memory data page of an operating system, and therefore, the memory data may also be moved in a unit of memory data page. That is, the memory data located on the remote node is replicated to the memory of the local node in a unit of memory data page.

In addition, in order to prevent the memory data from being accessed by another device during memory data replication, a corresponding memory data page may be locked, and then the locked memory data page is unlocked after replication is completed, so that the memory data page may continue to run. That is, before the step of “replicating the memory data located on the remote node to a memory of a local node”, the memory data access method may further include locking a memory data page on which the memory data that needs to be replicated is located.

Correspondingly, after the step of “replicating the memory data located on the remote node to a memory of a local node”, the memory data access method may further include unlocking the memory data page on which the replicated memory data is located.

102: Access the memory data located on the remote node from the memory of the local node.

For example, if in step 101, the process of the node0 has already written the memory data Data(A) to the target physical address P(B), the memory data Data(A) may be read from the physical address P(B) in this case.

It can be learned from the foregoing that, in this embodiment, when it is determined, according to a preset rule, that memory data located on a remote node needs to be frequently accessed, the memory data located on the remote node is replicated to a memory of a local node (that is, the memory data located on the remote node is moved to the local node), and then the memory data located on the remote node is accessed from the memory of the local node. Because a delay of accessing a memory of a processor in a local node is much less than a delay of accessing a memory of a remote processor, even if time for moving the memory data is added, when the memory data located on a remote node needs to be frequently accessed, a delay of reading the memory data located on the remote node may be significantly reduced by using the solution, thereby significantly improving system performance.

### Embodiment 2

According to the method described in Embodiment 1, the following is described in detail with an example.

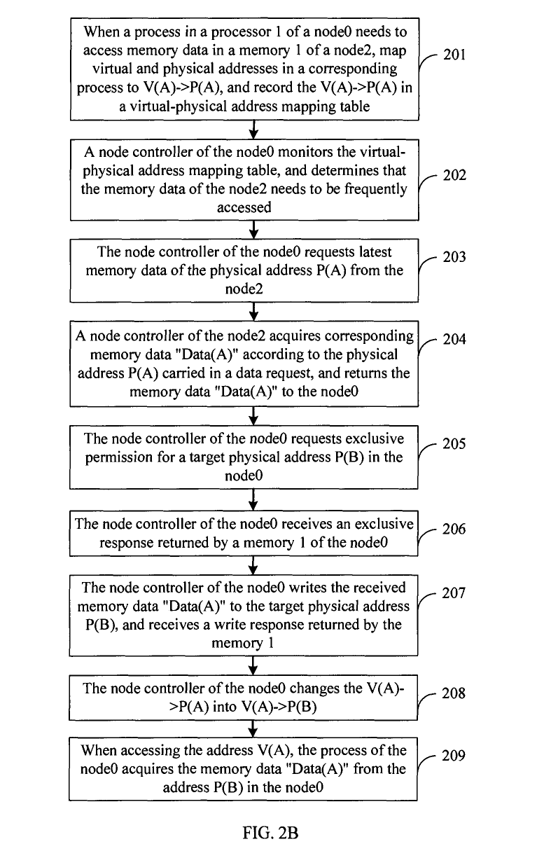

As shown in FIG. 2A, the CC-NUMA system may include N+1 nodes, that is, a node0, a node1, a node2, . . . , and a nodeN, where each node may include n processors (maybe Central Processing Units (CPUs)), and each processor has its own L3 cache and a corresponding memory. For example, a processor 1 in the node0 corresponds to a memory 1 in the node0, a processor n in the node0 corresponds to a memory n in the node0, a processor 1 in the node2 corresponds to a memory 1 in the node2, and a processor n in the node2 corresponds to a memory n in the node2. The processors in each node are connected by using an NC in the node to which the processors belong, and the nodes communicate with each other by using respective NCs.

In this embodiment, descriptions are given by using an example in which the node0 accesses memory data in the node2. As shown in FIG. 2B, a specific process for a memory data access method may be as follows.

201: When a process in a processor 1 of a node0 needs to access memory data in a memory 1 of a node2, map virtual and physical addresses in a corresponding process to V(A)->P(A), and record the V(A)->P(A) in a virtual-physical address mapping table.

The V(A) is the virtual address, and the P(A) is the physical address of the data that needs to be accessed.

202: A NC of the node0 monitors the virtual-physical address mapping table, and if it is determined that the memory data of the node2 needs to be frequently accessed, executes step 203.

There may be multiple manners of determining whether the memory data of the node2 is frequently accessed. For example, the virtual-physical address mapping table may be monitored, and if the number of physical addresses that are in the virtual-physical address mapping table and point to the node2 is greater than a preset threshold, it indicates that the memory data of the node2 needs to be frequently accessed.

The threshold may be set according to a requirement of an actual application.

203: The NC of the node0 requests latest memory data of the physical address P(A) from the node2.

For example, a data request, such as an exclusive request, may be sent to the node2, where the data request (for example, the exclusive request) carries the physical address P(A) of the requested memory data. For example, reference may be made to step 1 in FIG. 2C, and FIG. 2C is a schematic diagram of a scenario of the memory data access method.

204: After receiving a data request sent by the node0, an NC of the node2 acquires corresponding memory data “Data(A)” according to the physical address P(A) carried in the data request, and returns the memory data “Data(A)” to the node0 by means of a data response.

For example, reference may be made to step 2 in FIG. 2C. Because the physical address P(A) is located in a memory, that is, a memory 0, corresponding to a processor 0 in the node2, the NC of the node2 may transport the received data request to the processor 0 in the node2; the processor 0 acquires the memory data “Data(A)”, and forwards the acquired memory data “Data(A)” to the NC of the node2; and the NC of the node2 returns the memory data “Data(A)” to the node0 by means of the data response.

It should be noted that, when the node0 sends the data request, for example, sends the exclusive request, a cache coherence (CC) protocol has to be met. That is, it is required to perform interception according to a table of contents and a requirement, and the data can be moved correctly only after an exclusive state data response or exclusive permission is obtained. Therefore, before returning the data response to the node0, the node2 further needs to perform interception. For example, the step may be as follows.

The NC of the node0 sends an exclusive request about the physical address P(A) to the node2, which means that the node0 needs to obtain exclusive permission for the data corresponding to the physical address P(A). Because all processors in the CC-NUMA system may access the physical address P(A), if it is assumed that some processors in a node1 cache the data of the physical address P(A), after the exclusive request reaches the processor 0 of the node2, the processor 0 may initiate, according to the CC protocol, interception to the node1 that caches the data of the physical address P(A), that is, notify another node to invalidate the data (if there is dirty data, the dirty data needs to be written back to a primary memory). In this case, the node1 may return a response indicating the data is invalid, so as to ensure the exclusive permission of the node0 for the physical address P(A). With interception processing, the memory data corresponding to the physical address P(A) may have no other duplicates in other nodes except the node2, and a processor that manages the physical address P(A) has a latest data duplicate.

After the interception, the node2 may return the data response to the node0, to ensure that the node0 can obtain the latest data duplicate of the physical address P(A). That is, the corresponding memory data “Data(A)” is acquired according to the physical address P(A) carried in the data request (for example, the exclusive request), and the memory data “Data(A)” is returned to the node0 by means of the data response.

205: After receiving the data response sent by the node2, the NC of the node0 sends an exclusive permission request to a memory 1 in the node0 (reference may be made to step 3 in FIG. 2C), to request exclusive permission for a target physical address P(B) in the node0.

For example, the NC of the node0 may control a processor 0, and the processor 0 sends the exclusive permission request to the memory 1 in the node0, to request the exclusive permission for the target physical address P(B) in the node0.

206: The NC of the node0 receives an exclusive response returned by the memory 1 of the node0 (reference may be made to step 4 in FIG. 2C), so as to obtain the exclusive permission for the target physical address P(B).

For example, the processor 0 of the node0 may receive the exclusive response returned by the memory 1 of the node0, and then the processor 0 of the node0 transports the exclusive response to the NC of the node0.

207: After obtaining the exclusive permission for the target physical address P(B), the NC of the node0 writes the received memory data “Data(A)” to the target physical address P(B), and receives a write response returned by the memory 1 (reference may be made to step 5 and step 6 in FIG. 2C).

For example, the NC of the node0 may control the processor 0 of the node0, and the processor 0 of the node0 writes the received memory data “Data(A)” to the target physical address P(B), and receives the write response returned by the memory 1, and then the processor 0 of the node0 transports the write response to the NC of the node0.

208: The NC of the node0 updates the physical address, in the virtual-physical address mapping table, of the received memory data to the target physical address, that is, changes the V(A)->P(A) into V(A)->P(B).

209: When accessing the address V(A), the process of the node0 acquires the memory data “Data(A)” from the address P(B) in the node0.

It can be learned from the foregoing that. in this embodiment, when a node0 determines that memory data of a remote node, such as a node2, needs to be frequently accessed, the memory data located on the remote node is replicated to a memory of a local node (that is, the memory data located on the remote node is moved to the local node), and then the memory data located on the remote node is accessed from the memory of the local node. Because a delay of accessing a memory of a processor in a local node is much less than a delay of accessing a memory of a remote processor, even if time for moving the memory data is added, when the memory data located on a remote node needs to be frequently accessed, a delay of reading the memory data located on the remote node may be significantly reduced by using the solution, thereby significantly improving system performance.

### Embodiment 3

Based on Embodiment 2, further, in order to prevent memory data from being accessed by another device during memory data replication, a corresponding memory data page (for example, both memory loading and an address mapping table are performed in a unit of memory data page of an operating system) may be locked, and then the locked memory data page is unlocked after replication is completed, and details will be described below.

In this embodiment, descriptions are given still by taking a structure of the CC-NUMA system shown in FIG. 2A as an example.

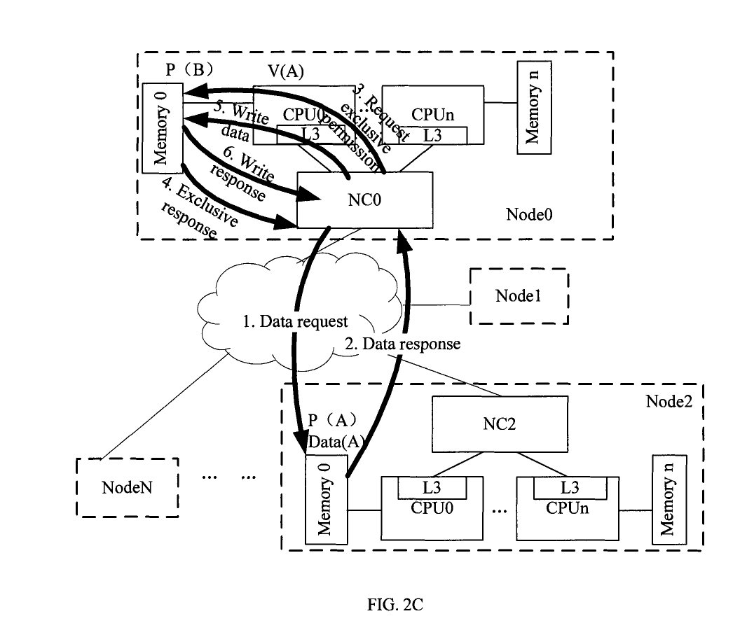

A memory data access method is shown in FIG. 3, and a specific process may be as follows.

301: When a process in a processor 1 of a node0 needs to access memory data in a memory 1 of a node2, map virtual and physical addresses in a corresponding process to V(A)->P(A), and record the V(A)->P(A) in a virtual-physical address mapping table.

The V(A) is the virtual address, and the P(A) is the physical address of the data that needs to be accessed.

302: An NC of the node0 monitors the virtual-physical address mapping table, and if it is determined that the memory data of the node2 needs to be frequently accessed, executes step 303.

There may be multiple manners of determining whether the memory data of the node2 is frequently accessed. For example, the virtual-physical address mapping table may be monitored, and if the number of physical addresses that are in the virtual-physical address mapping table and point to the node2 is greater than a preset threshold, it indicates that the memory data of the node2 needs to be frequently accessed.

The threshold may be set according to a requirement of an actual application.

303: The NC of the node0 locks a memory data page on which the memory data that needs to be replicated is located, and then executes step 304.

304: The NC of the node0 requests latest memory data of the physical address P(A) from the node2.

For example, a data request, such as an exclusive request, may be sent to the node2, where the data request (for example, the exclusive request) carries the physical address P(A) of the requested memory data. For example, reference may be made to step 1 in FIG. 2C, and FIG. 2C is a schematic diagram of a scenario of the memory data access method.

305: After receiving a data request sent by the node0, an NC of the node2 acquires corresponding memory data “Data(A)” according to the physical address P(A) carried in the data request, and returns the memory data “Data(A)” to the node0 by means of a data response.

For example, reference may be made to step 2 in FIG. 2C. Because the physical address P(A) is located in a memory, that is, a memory 0, corresponding to a processor 0 in the node2, the NC of the node2 may transport the received data request to the processor 0 in the node2; the processor 0 acquires the memory data “Data(A)”, and forwards the acquired memory data “Data(A)” to the NC of the node2; and the NC of the node2 returns the memory data “Data(A)” to the node0 by means of the data response.

It should be noted that, when the node0 sends the data request, for example, sends the exclusive request, a CC protocol has to be met. That is, it is required to perform interception according to a table of contents and a requirement, and the data can be moved correctly only after an exclusive state data response or exclusive permission is obtained. Therefore, before returning the data response to the node0, the node2 further needs to perform interception. For example, the step may be as follows.

The NC of the node0 sends an exclusive request about the physical address P(A) to the node2, which means that the node0 needs to obtain exclusive permission for the data corresponding to the physical address P(A). Because all processors in the CC-NUMA system may access the physical address P(A), if it is assumed that some processors in a node1 cache the data of the physical address P(A), after the exclusive request reaches the processor 0 of the node2, the processor 0 may initiate, according to the CC protocol, interception to the node1 that caches the data of the physical address P(A), that is, notify another node to invalidate the data (if there is dirty data, the dirty data needs to be written back to a primary memory). In this case, the node1 may return a response indicating the data is invalid, so as to ensure the exclusive permission of the node0 for the physical address P(A). With interception processing, the memory data corresponding to the physical address P(A) has no other duplicates in other nodes except the node2, and a processor that manages the physical address P(A) has a latest data duplicate.

After the interception, the node2 may return the data response to the node0, to ensure that the node0 can obtain the latest data duplicate of the physical address P(A). That is, the corresponding memory data “Data(A)” is acquired according to the physical address P(A) carried in the data request (for example, the exclusive request), and the memory data “Data(A)” is returned to the node0 by means of the data response.

306: After receiving the data response sent by the node2, the NC of the node0 sends an exclusive permission request to a memory 1 in the node0 (reference may be made to step 3 in FIG. 2C), to request exclusive permission for a target physical address P(B) in the node0.

For example, the NC of the node0 may control a processor 0, and the processor 0 sends the exclusive permission request to the memory 1 in the node0, to request the exclusive permission for the target physical address P(B) in the node0.

307: The NC of the node0 receives an exclusive response returned by the memory 1 of the node0 (reference may be made to step 4 in FIG. 2C), so as to obtain the exclusive permission for the target physical address P(B).

For example, the processor 0 of the node0 may receive the exclusive response returned by the memory 1 of the node0, and then the processor 0 of the node0 transports the exclusive response to the NC of the node0.

308: After obtaining the exclusive permission for the target physical address P(B), the NC of the node0 writes the received memory data “Data(A)” to the target physical address P(B), and receives a write response returned by the memory 1 (reference may be made to step 5 and step 6 in FIG. 2C).

For example, the NC of the node0 may control the processor 0 of the node0, and the processor 0 of the node0 writes the received memory data “Data(A)” to the target physical address P(B), and receives the write response returned by the memory 1, and then the processor 0 of the node0 transports the write response to the NC of the node0.

309: The NC of the node0 updates the physical address, in the virtual-physical address mapping table, of the received memory data to the target physical address, that is, changes the V(A)->P(A) into V(A)->P(B).

310: The NC of the node0 unlocks the memory data page on which the replicated memory data is located.

311: When accessing the address V(A), the process of the node0 acquires the memory data “Data(A)” from the address P(B) in the node0.

It can be learned from the foregoing that, in this embodiment, when a node0 determines that memory data of a remote node, such as a node2, needs to be frequently accessed, the memory data located on the remote node may be replicated to a memory of a local node, and then the memory data located on the remote node is accessed from the memory of the local node. Because a delay of accessing a memory of a processor in a local node is much less than a delay of accessing a memory of a remote processor, even if time for moving the memory data is added, when the memory data located on a remote node needs to be frequently accessed, a delay of reading the memory data located on the remote node may also be significantly reduced by using the solution, thereby significantly improving system performance. Further, in this embodiment, before the memory data located on the remote node is replicated to the memory of the local node, the memory data that needs to be replicated may further be locked, and be unlocked only after replication is completed. Therefore, other devices may be prevented from accessing the memory data during this period, a replication error may be avoided, and data accuracy may be ensured, thereby further improving system performance.

### Embodiment 4

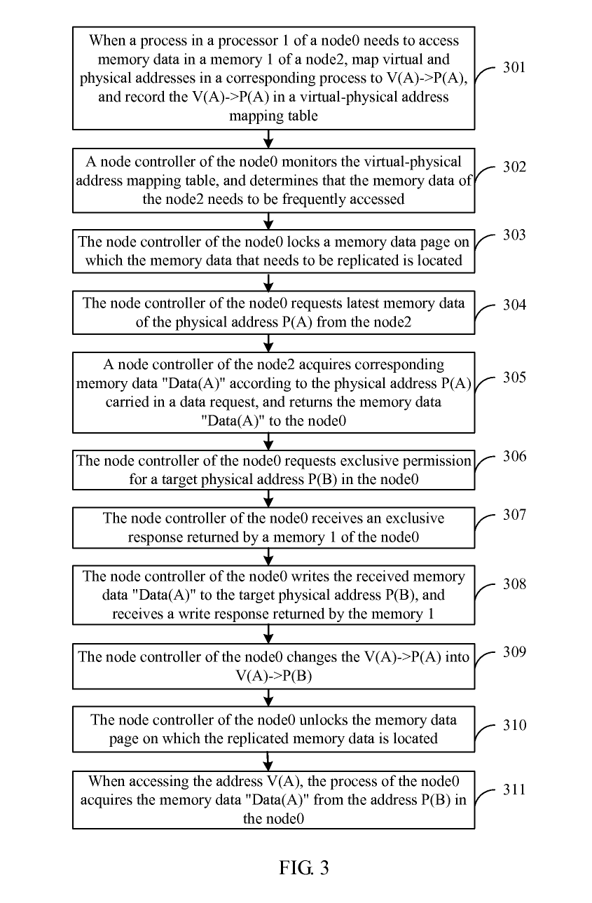

Correspondingly, the embodiments of the present invention further provide a memory data access apparatus, which is applied to a CC-NUMA system. As shown in FIG. 4, the memory data access apparatus includes a replicating unit 401 and an access unit 402.

The replicating unit 401 is configured to, when it is determined, according to a preset rule, that memory data located on a remote node needs to be frequently accessed, replicate the memory data located on the remote node to a memory of a local node.

The access unit 402 is configured to access the memory data located on the remote node from the memory of the local node.

The replicating unit 401 may include a request subunit, a receiving subunit, and a write subunit.

The request subunit is configured to, when it is determined, according to the preset rule, that the memory data located on the remote node needs to be frequently accessed, send a data request to the remote node, where the data request carries information such as a physical address of requested memory data.

The receiving subunit is configured to receive the memory data returned by the remote node according to the physical address.

The write subunit is configured to, after exclusive permission for a target physical address in the memory of the local node is acquired, write the received memory data to the target physical address.

The preset rule may be set according to a requirement of an actual application. That is, there may be multiple manners of determining whether the memory data located on the remote node is frequently accessed. For example, a virtual-physical address mapping table may be monitored, and if the number of physical addresses that are in the virtual-physical address mapping table and point to the remote node is greater than a preset threshold, it indicates that the memory data located on the remote node needs to be frequently accessed.

The request subunit may be configured to monitor a virtual-physical address mapping table, and when it is determined that the number of physical addresses that are in the virtual-physical address mapping table and point to the remote node is greater than the preset threshold, send the data request to the remote node, where the data request carries the physical address of the requested memory data.

The virtual-physical address mapping table is used to store a mapping relationship between a virtual address and a physical address of the memory data, and the threshold may be set according to a requirement of an actual application.

In addition, after the received memory data is written to the target physical address, that is, after the memory data is written back, the physical address, in the virtual-physical address mapping table, of the received memory data may further be updated to the target physical address. For example, if an original physical address is P(A), and the target physical address is P(B), V(A)->P(A) may be changed into V(A)->P(B). In this way, when a process of a node0 accesses the address V(A) subsequently, the address V(A) may be mapped to the address P(B) in the node0, so that the process may work with a low delay. That is, the replicating unit 401 may further include an updating subunit.

The updating subunit is configured to update the physical address, in the virtual-physical address mapping table, of the received memory data to the target physical address.

Generally, both memory loading and an address mapping table are performed in a unit of memory data page of an operating system, and therefore, the memory data may also be moved in a unit of memory data page. That is, the memory data located on the remote node is replicated to the memory of the local node in a unit of memory data page.

In addition, in order to prevent the memory data from being accessed by another device during memory data replication, a corresponding memory data page may be locked, and then the locked memory data page is unlocked after replication is completed, so that the memory data page may continue to run. That is, the memory data access apparatus may further include a locking unit and an unlocking unit as follows.

The replicating unit may be configured to replicate the memory data located on the remote node to the memory of the local node in a unit of memory data page.

The locking unit is configured to, before the memory data located on the remote node is replicated to the memory of the local node, lock a memory data page on which the memory data that needs to be replicated is located.

The unlocking unit is configured to, after the memory data located on the remote node is replicated to the memory of the local node, unlock the memory data page on which the replicated memory data is located.

The memory data access apparatus may be a device such as an NC.

During specific implementation, each of the foregoing units may be implemented as an independent entity, and may also be implemented as a same entity or several entities by random combination. For specific implementation of each of the foregoing units, reference may be to the foregoing embodiments, and details are not described herein again.

It can be learned from the foregoing that, in the memory data access apparatus of this embodiment, a replicating unit 401 may replicate, when it is determined, according to a preset rule, that memory data located on a remote node needs to be frequently accessed, the memory data located on the remote node to a memory of a local node (that is, move the memory data located on the remote node to the local node), and then an access unit 402 accesses the memory data located on the remote node from the memory of the local node. Because a delay of accessing a memory of a processor in a local node is much less than a delay of accessing a memory of a remote processor, even if time for moving the memory data is added, when the memory data located on a remote node needs to be frequently accessed, a delay of reading the memory data located on the remote node may be significantly reduced by using the solution, thereby significantly improving system performance.

### Embodiment 5

Correspondingly, the embodiments of the present invention further provide a communications system, including any memory data access apparatus provided by the embodiments of the present invention. For example, the system may be as follows.

The memory data access apparatus is configured to, when it is determined, according to a preset rule, that memory data located on a remote node needs to be frequently accessed, replicate the memory data located on the remote node to a memory of a local node, and access the memory data located on the remote node from the memory of the local node.

For example, the memory data access apparatus may be configured to, when it is determined, according to the preset rule, that the memory data located on the remote node needs to be frequently accessed, send a data request to the remote node, where the data request carries information such as a physical address of requested memory data; receive the memory data returned by the remote node according to the physical address; and after exclusive permission for a target physical address in the memory of the local node is acquired, write the received memory data to the target physical address.

The preset rule may be set according to a requirement of an actual application. That is, there may be multiple manners of determining whether the memory data located on the remote node is frequently accessed. For example, a virtual-physical address mapping table may be monitored, and if the number of physical addresses that are in the virtual-physical address mapping table and point to the remote node is greater than a preset threshold, it indicates that the memory data located on the remote node needs to be frequently accessed.

The memory data access apparatus may be configured to monitor a virtual-physical address mapping table, and when it is determined that the number of physical addresses that are in the virtual-physical address mapping table and point to the remote node is greater than the preset threshold, send the data request to the remote node, where the data request carries the physical address of the requested memory data.

The virtual-physical address mapping table is used to store a mapping relationship between a virtual address and a physical address of the memory data, and the threshold may be set according to a requirement of an actual application.

In addition, after the received memory data is written to the target physical address, that is, after the memory data is written back, the physical address, in the virtual-physical address mapping table, of the received memory data may further be updated to the target physical address. For example, if an original physical address is P(A), and the target physical address is P(B), V(A)->P(A) may be changed into V(A)->P(B). In this way, when a process of a node0 accesses the address V(A) subsequently, the address V(A) may be mapped to the address P(B) in the node0, so that the process may work with a low delay.

The memory data access apparatus may be further configured to update the physical address, in the virtual-physical address mapping table, of the received memory data to the target physical address.

Generally, both memory loading and an address mapping table are performed in a unit of memory data page of an operating system, and therefore, the memory data may also be moved in a unit of memory data page. That is, the memory data located on the remote node is replicated to the memory of the local node in a unit of memory data page.

In addition, in order to prevent the memory data from being accessed by another device during memory data replication, a corresponding memory data page may be locked, and then the locked memory data page is unlocked after replication is completed, so that the memory data page may continue to run.

The memory data access apparatus may be further configured to, before the memory data located on the remote node is replicated to the memory of the local node, lock a memory data page on which the memory data that needs to be replicated is located; and after the memory data located on the remote node is replicated to the memory of the local node, unlock the memory data page on which the replicated memory data is located.

In addition, the communications system may further include other devices, such as a terminal and a server. For specific implementation of the memory data access apparatus, reference may be made to the foregoing embodiments, and details are not described herein again.

The communications system is described briefly by using an example.

For example, the communications system may include a first node and a second node, where both the first node and the second node include an NC, and the memory data access apparatus provided by the embodiments of the present invention is integrated into the NC, which may be as follows.

The first node is configured to, when it is determined, according to a preset rule, that memory data of the second node needs to be frequently accessed, send a data request to the second node, where the data request carries information such as a physical address of requested memory data; receive the memory data returned by the second node according to the physical address; and after exclusive permission for a target physical address in a memory of a local node (that is, the first node) is acquired, write the received memory data to the target physical address.

The second node is configured to receive the data request sent by the first node, acquire the memory data according to the physical address of the requested memory data, and send the memory data to the first node.

For example, the first node may monitor a virtual-physical address mapping table, and when it is determined that the number of physical addresses that are in the virtual-physical address mapping table and point to the remote node is greater than a preset threshold, send the data request to the remote node, where the data request carries the physical address of the requested memory data.

In addition, the first node may further be configured to, after the received memory data is written to the target physical address, update the physical address, in the virtual-physical address mapping table, of the received memory data to the target physical address.

The first node may further be configured to, before the memory data located on the remote node is replicated to the memory of the local node, lock a memory data page on which the memory data that needs to be replicated is located; and after the memory data located on the remote node is replicated to the memory of the local node, unlock the memory data page on which the replicated memory data is located.

In addition, it should be further noted that, before the first node sends the data request, for example, sends an exclusive request, a CC protocol has to be met. That is, it is required to perform interception according to a table of contents and a requirement, and the data can be moved correctly only after an exclusive state data response or exclusive permission is obtained. Therefore, before returning the data response to the first node, the second node further needs to perform interception.

The second node is further configured to initiate, according to the CC protocol, interception to another node that caches the memory data requested by the first node, that is, notify the another node to invalidate the data (if there is dirty data, the dirty data needs to be written back to a primary memory). Reference may be made to the foregoing embodiments, and details are not described herein again.

It can be learned from the foregoing that, in the communications system of this embodiment, when it is determined, according to a preset rule, that memory data located on a remote node needs to be frequently accessed, the memory data located on the remote node is replicated to a memory of a local node (that is, the memory data located on the remote node is moved to the local node), and then the memory data located on the remote node is accessed from the memory of the local node. Because a delay of accessing a memory of a processor in a local node is much less than a delay of accessing a memory of a remote processor, even if time for moving the memory data is added, when the memory data located on a remote node needs to be frequently accessed, a delay of reading the memory data located on the remote node may be significantly reduced by using the solution, thereby significantly improving system performance.

### Embodiment 6

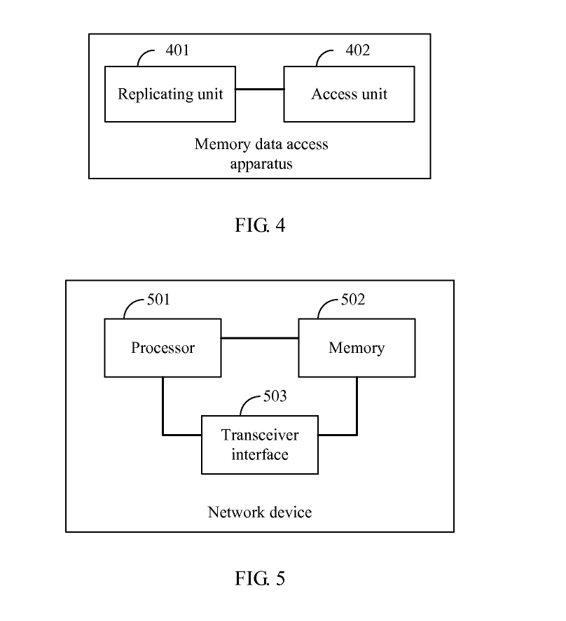

In addition, the embodiments of the present invention further provide a network device. As shown in FIG. 5, the network device includes a processor 501, a memory 502 configured to store data, and a transceiver interface 503 configured to receive and transmit data.

The processor 501 is configured to, when it is determined, according to a preset rule, that memory data located on a remote node needs to be frequently accessed, replicate the memory data located on the remote node to a memory of a local node, and access the memory data located on the remote node from the memory of the local node.

For example, the processor 501 may be configured to, when it is determined, according to the preset rule, that the memory data located on the remote node needs to be frequently accessed, send a data request to the remote node by using the transceiver interface 503, where the data request carries information such as a physical address of requested memory data; receive, by using the transceiver interface 503, the memory data returned by the remote node according to the physical address; and after exclusive permission for a target physical address in the memory of the local node is acquired, write the received memory data to the target physical address.

The preset rule may be set according to a requirement of an actual application. That is, there may be multiple manners of determining whether the memory data located on the remote node is frequently accessed. For example, a virtual-physical address mapping table may be monitored, and if the number of physical addresses that are in the virtual-physical address mapping table and point to the remote node is greater than a preset threshold, it indicates that the memory data located on the remote node needs to be frequently accessed.

The processor 501 may be configured to monitor a virtual-physical address mapping table, and when it is determined that the number of physical addresses that are in the virtual-physical address mapping table and point to the remote node is greater than a preset threshold, send the data request to the remote node by using the transceiver interface 503, where the data request carries the physical address of the requested memory data.

The virtual-physical address mapping table is used to store a mapping relationship between a virtual address and a physical address of the memory data, and the threshold may be set according to a requirement of an actual application.

In addition, after the received memory data is written to the target physical address, that is, after the memory data is written back, the physical address, in the virtual-physical address mapping table, of the received memory data may further be updated to the target physical address. For example, if an original physical address is P(A), and the target physical address is P(B), V(A)->P(A) may be changed into V(A)->P(B). In this way, when a process of a node0 accesses the address V(A) subsequently, the address V(A) may be mapped to the address P(B) in the node0, so that the process may work with a low delay.

The processor 501 may be further configured to update the physical address, in the virtual-physical address mapping table, of the received memory data to the target physical address.

Generally, both memory loading and an address mapping table are performed in a unit of memory data page of an operating system, and therefore, the memory data may also be moved in a unit of memory data page. That is, the memory data located on the remote node is replicated to the memory of the local node in a unit of memory data page.

In addition, in order to prevent the memory data from being accessed by another device during memory data replication, a corresponding memory data page may be locked, and then the locked memory data page is unlocked after replication is completed, so that the memory data page may continue to run.

The processor 501 may further be configured to, before the memory data located on the remote node is replicated to the memory of the local node, lock a memory data page on which the memory data that needs to be replicated is located; and after the memory data located on the remote node is replicated to the memory of the local node, unlock the memory data page on which the replicated memory data is located.

For specific implementation of the foregoing operations, reference may be made to the foregoing embodiments, and details are not described herein again.

It can be learned from the foregoing that, in the network device of this embodiment, when it is determined, according to a preset rule, that memory data located on a remote node needs to be frequently accessed, the memory data located on the remote node is replicated to a memory of a local node (that is, the memory data located on the remote node is moved to the local node), and then the memory data located on the remote node is accessed from the memory of the local node. Because a delay of accessing a memory of a processor in a local node is much less than a delay of accessing a memory of a remote processor, even if time for moving the memory data is added, when the memory data located on a remote node needs to be frequently accessed, a delay of reading the memory data located on the remote node may be significantly reduced by using the solution, thereby significantly improving system performance.

A person of ordinary skill in the art may understand that all or a part of the steps of the methods in the embodiments may be implemented by a program instructing relevant hardware. The program may be stored in a computer readable storage medium. The storage medium may include a read-only memory (ROM), a random access memory (RAM), a magnetic disk, an optical disc, or the like.

The foregoing describes in detail the memory data access method and apparatus, and the system provided in the embodiments of the present invention. Although the principles and implementation manners of the present invention are described by using specific examples, the foregoing embodiments are only intended to help understand the method and core idea of the present invention. In addition, with respect to the specific implementation manners and applicability of the present invention, modifications may be made by a person skilled in the art according to the idea of the present invention. Therefore, the specification shall not be construed as a limitation on the present invention.

1. A memory data access method applied to a cache coherence non-uniform memory access system, comprising:
replicating memory data located on a remote node to a memory of a local node when determining, according to a preset rule, that the memory data located on the remote node needs to be frequently accessed; and
accessing the memory data located on the remote node from the memory of the local node.

2. The method according to claim 1, wherein replicating the memory data located on the remote node to the memory of the local node comprises:
sending a data request to the remote node, wherein the data request carries a physical address of requested memory data;
receiving the memory data returned by the remote node according to the physical address; and
writing the received memory data to a target physical address after exclusive permission for the target physical address in the memory of the local node is acquired.

3. The method according to claim 2, wherein determining, according to the preset rule, that the memory data located on the remote node needs to be frequently accessed comprises:
monitoring a virtual-physical address mapping table, wherein the virtual-physical address mapping table is used to store a mapping relationship between a virtual address and the physical address of the memory data; and
determining that the memory data located on the remote node needs to be frequently accessed when determining that the number of physical addresses that are in the virtual-physical address mapping table and point to the remote node is greater than a preset threshold.

4. The method according to claim 3, wherein after writing the received memory data to the target physical address, the method further comprises updating the physical address, in the virtual-physical address mapping table, of the received memory data to the target physical address.

5. The method according to claim 1, wherein the memory data located on the remote node is replicated to the memory of the local node in a unit of memory data page, and before replicating the memory data located on the remote node to the memory of the local node, the method further comprises locking a memory data page on which the memory data that needs to be replicated is located, and wherein after replicating the memory data located on the remote node to the memory of the local node, the method further comprises unlocking the memory data page on which the replicated memory data is located.

6. A memory data access apparatus applied to a cache coherence non-uniform memory access system, comprising:
a replicating unit configured to replicate memory data located on a remote node to a memory of a local node when determining, according to a preset rule, that the memory data located on the remote node needs to be frequently accessed; and
an access unit configured to access the memory data located on the remote node from the memory of the local node.

7. The memory data access apparatus according to claim 6, wherein the replicating unit comprises a request subunit, a receiving subunit, and a write subunit, wherein the request subunit is configured to send a data request to the remote node when determining, according to the preset rule, that the memory data located on the remote node needs to be frequently accessed, wherein the data request carries a physical address of requested memory data, wherein the receiving subunit is configured to receive the memory data returned by the remote node according to the physical address, and wherein the write subunit is configured to write the received memory data to a target physical address after exclusive permission for the target physical address in the memory of the local node is acquired.

8. The memory data access apparatus according to claim 7, wherein the request subunit is configured to:
monitor a virtual-physical address mapping table, wherein the virtual-physical address mapping table is used to store a mapping relationship between a virtual address and a physical address of the memory data; and
send the data request to the remote node when determining that the number of physical addresses that are in the virtual-physical address mapping table and point to the remote node is greater than a preset threshold, wherein the data request carries the physical address of the requested memory data.

9. The memory data access apparatus according to claim 8, wherein the replicating unit further comprises an updating subunit, wherein the updating subunit is configured to update the physical address, in the virtual-physical address mapping table, of the received memory data to the target physical address.

10. The memory data access apparatus according to claim 6, further comprising a locking unit and an unlocking unit, wherein the replicating unit is configured to replicate the memory data located on the remote node to the memory of the local node in a unit of memory data page, wherein the locking unit is configured to lock a memory data page on which the memory data that needs to be replicated is located before the memory data located on the remote node is replicated to the memory of the local node, and wherein the unlocking unit is configured to unlock the memory data page on which the replicated memory data is located to after the memory data located on the remote node is replicated to the memory of the local node.

11. The memory data access apparatus according to claim 6, wherein the memory data access apparatus is comprised in a communications system.
